(19) United States
(12) Patent Application Publication
(10) Pub. No.: US 2025/0125956 A1
(43) Pub. Date: Apr. 17, 2025

(54) COMMUNICATION POLICY ENFORCEMENT USING A SECURE PLAINTEXT LABEL

(71) Applicant: Microsoft Technology Licensing, LLC, Redmond, WA (US)

(72) Inventors: John Wan Yeung SUN, Redmond, WA (US); Ashok NANDOORI, Frisco, TX (US); Adithya GUNDMI GUNDMI RAMESH, Issaquah, WA (US); Abhishek Kumar TIWARI, Woodinville, WA (US)

(21) Appl. No.: 18/486,648

(22) Filed: Oct. 13, 2023

(51) Int. Cl. H04L 9/32; H04L 45/302; H04L 47/20

(52) U.S. Cl. CPC H04L 9/32; H04L 45/302; H04L 47/20

(57) ABSTRACT

Enforcement of a communication policy at a communication intermediary configured to communicate between a first communicating entity and a second communicating entity is provided. The communication intermediary includes packet routers. The enforcement includes identifying, by the packet routers of the communication intermediary, a secure plaintext label in each network packet of labeled network traffic received at the packet routers, evaluating whether the labeled network traffic satisfies an enforcement condition of the communication policy based on the secure plaintext label, instructing a network controller to operate on the labeled network traffic according to the communication policy, based on the operation of evaluating. Each network packet includes encrypted content configured to be inaccessible by the packet routers. The secure plaintext label is accessible by the packet routers and includes a data encoding of a portion of the encrypted content.

### BACKGROUND

Network servers handle a large number of requests from different users. Some of these users are bad actors and disrupt network servers using Denial-of-Service (DOS) attacks. DOS attacks send large volumes of data to a network server over a short period of time. A special type of DOS attack, a Distributed Denial of Service (DDOS) attack, sends a large volume of data from multiple communication sources. Because the DDOS attack is made from multiple communication sources, the DDOS attack is difficult to identify in time to prevent or mitigate damage from the attack. DDOS attacks overwhelm the finite network resources of the network server, preventing the network resources from being used to service requests from legitimate users.

### SUMMARY

The presently described technology provides the enforcement of a communication policy at a communication intermediary configured to communicate between a first communicating entity and a second communicating entity. The communication intermediary includes packet routers. The enforcement includes identifying, by the packet routers, a secure plaintext label in each network packet of labeled network traffic received at the packet routers, evaluating whether the labeled network traffic satisfies an enforcement condition of the communication policy based on the secure plaintext label, instructing a network controller to operate on the labeled network traffic according to the communication policy, based on the operation of evaluating. Each network packet includes encrypted content configured to be inaccessible by the packet routers. The secure plaintext label is accessible by the packet routers and includes a data encoding of a portion of the encrypted content.

This summary is provided to introduce a selection of concepts in a simplified form. The concepts are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example system for enforcing a communication policy at a communication intermediary.

FIG. 2 illustrates a schematic view of an example system for enforcing a communication policy at a communication intermediary.

FIG. 3 illustrates an example network packet including a secure plaintext label.

FIG. 4 illustrates example operations for enforcing a communication policy at a communication intermediary.

FIG. 5 illustrates an example computing device for use in implementing the described technology.

### DETAILED DESCRIPTION

In some network systems, a network proxy acts as a communication intermediary for communications between a communication source, such as a user or client system, and a communication destination, such as a host or tenant domain. The network proxy provides services, including threat detection and isolation to the communication destination. The communication intermediary discriminates between legitimate traffic and malicious traffic to prevent attacks, such as denial of service (DOS) attacks. In some systems, data of a communication is parsed and transmitted over the network in network packets. In some traditional network protocol systems, these network packets include metadata in headers that include communication label data that identify features of the communication source or destination. Network controllers of the communication intermediary assess network traffic with similar communication label data to help identify malicious traffic that represents an attack. For example, the communication label data can include data representing a particular domain to which network traffic is directed, and if too much traffic is addressed to that domain over a short period of time, the network controller identifies the network traffic as an attack.

In traditional network protocol systems, communication label data is provided in plaintext (e.g., unencrypted in a header), even when the payload of the network packet is encrypted. Lower-level (e.g., L2 or L3 routers) routers, referred to herein as packet routers, intermittent routers, or connectivity routers, are configured to access and process this plaintext data without decrypting encrypted portions of the network packet. The traditional network protocol systems can use this data accessible to the packet router to help identify threats before higher-level routers (e.g., L7 routers), referred to herein as application routers, decrypt and/or interpret the encrypted data in a slow operation. Determining whether the communication is malicious at the packet router before the payload is decrypted at the application router can provide sufficient time to stop or mitigate the damage a malicious communication can cause to a communication destination.

However, in the interest of improved security, some network protocols have changed (e.g., from HyperText Transfer Protocol (HTTP)/2 to HTTP/3) to limit the information provided in plaintext headers. Some items of the communication label data have been moved from the plaintext header portion to an encrypted portion of the network packet. For example, in HTTP/3 communication using quick user datagram protocol Internet connections (QUIC), the plaintext header accessible to packet routers includes some routing information, but other static communication label data useful in identifying a session, communication, or communication sequence (hereinafter referred to as a communication) is now encrypted in an encrypted portion of the network packets. Static communication label data is useful in identifying a communication because the static data does not change depending on connectivity. Other communication label data, such as a source IP address, can change if a device changes location (e.g., changes to a different position with different cellular network coverage). If the communication intermediary relies on this source IP that changes, the communication intermediary will erroneously identify a new communication after the change.

As discussed, in HTTP/3 communication using QUIC protocols, the plaintext header accessible to packet routers includes a QUIC plaintext QUIC header, but other information, such as a server name indicator (SNI), is now encrypted in an encrypted portion of the network packets. The SNI indicates the server in a domain of a communication destination to which network packets are directed and is useful in classifying harmful traffic. In these systems, the packet router is not configured to decrypt data in the encrypted portion of the network packet, so the packet router does not have access to the encrypted communication label data, such as the SNI. The encrypted communication label data later becomes accessible for assessing an attack when a higher-level application router decrypts the encrypted portion of the network packet; however, this may take sufficiently long that a malicious communication will pass through the communication intermediary (e.g., network proxy) to reach a tenant at the communication destination prior to detection. Therefore, an attack will affect the operation of the communication destination before the system has a chance to detect the attack.

The presently described technology introduces a secure plaintext label representing communication label data to network packets of communications. In implementations, the secure plaintext label represents static communication label data useable to consistently identify a communication. A packet router is configured to identify (e.g., read, access, and/or interpret) the secure plaintext label. While presented as plaintext, the secure plaintext label is secure in that a communication interceptor is unable to determine the information the secure plaintext label represents. In implementations, the secure plaintext label is an encoded, encrypted, or hashed representation of data also represented in an encrypted portion of a network packet. In other implementations, the secure encrypted label is an arbitrary or random sequence (e.g., an alphanumeric character string) that is generated to represent communication label data associated in memory at the communication intermediary with one or both of the communication source or the communication destination.

In an HTTP/3 QUIC communication example of the described technology, the secure plaintext label is included in a QUIC header. While the QUIC header of a network packet is accessible to a lower-level packet router and any interceptor, the secure plaintext label is encoded to secure communication label data that the secure plaintext header represents. In implementations, the secure plaintext label may be or may be a component of one or more connection IDs (e.g., a destination connection identifier or DCID) assigned by the communication intermediary to a communication in an initial handshake operation. In an implementation, the secure plaintext header represents a server identifier or a domain identifier identifying a server or domain to which the labeled network traffic labeled by the connection IDs and/or the secure plaintext label is addressed. In HTTP/3 QUIC protocols, the SNI is encrypted. However, in implementations, the plaintext secure label can include a data encoding of the SNI.

When the packet router receives a labeled network packet, the packet router identifies the secure plaintext label. Network traffic the packet router identifies as including the secure plaintext label that is directed to a particular communication destination is evaluated to determine whether the network traffic satisfies an enforcement condition. For example, network controllers can use the secure plaintext label read by the packet router to determine a magnitude or rate of network traffic labeled with the secure plaintext label to assess whether communications that include the secure plaintext label represent malicious traffic with the potential to harm the communication destination.

Based on the determination of whether the labeled network traffic satisfies the enforcement condition, the network controller operates on elements of the labeled network traffic. For example, if labeled network traffic addressed to a particular server exceeds a traffic threshold (e.g., a network packet or data rate threshold), the network controller will restrict (e.g., deny, reroute, or rate limit) access of the labeled network traffic to the communication destination. In turn, the secure plaintext label can help identify malicious traffic before the data contained in the packets of the malicious traffic is decrypted by a high-level application router in a slower decrypting operation.

Implementations are also contemplated in which the secure plaintext label is, additionally or alternatively, used to make quality of service (QOS) determinations. For example, the plaintext secure label can represent a requestor or a feature of a customer service level agreement term or subscription level of an entity making a request at the communication source. Depending on the secure plaintext label, the request may be processed with different computational resources, over different communication channels, and/or with a different prioritization.

Because the secure plaintext label is identifiable by the packet router and is secure, the secure plaintext label can be used to classify network traffic at the packet router (e.g., quickly relative to decryption and interpretation of data by the application router) without sacrificing the security of the data represented by the secure plaintext label. In a number of applications (e.g., security or QoS), the secure plaintext label allows for quick network controller decision-making to manage labeled network traffic without compromising the security that newer network communication protocols confer.

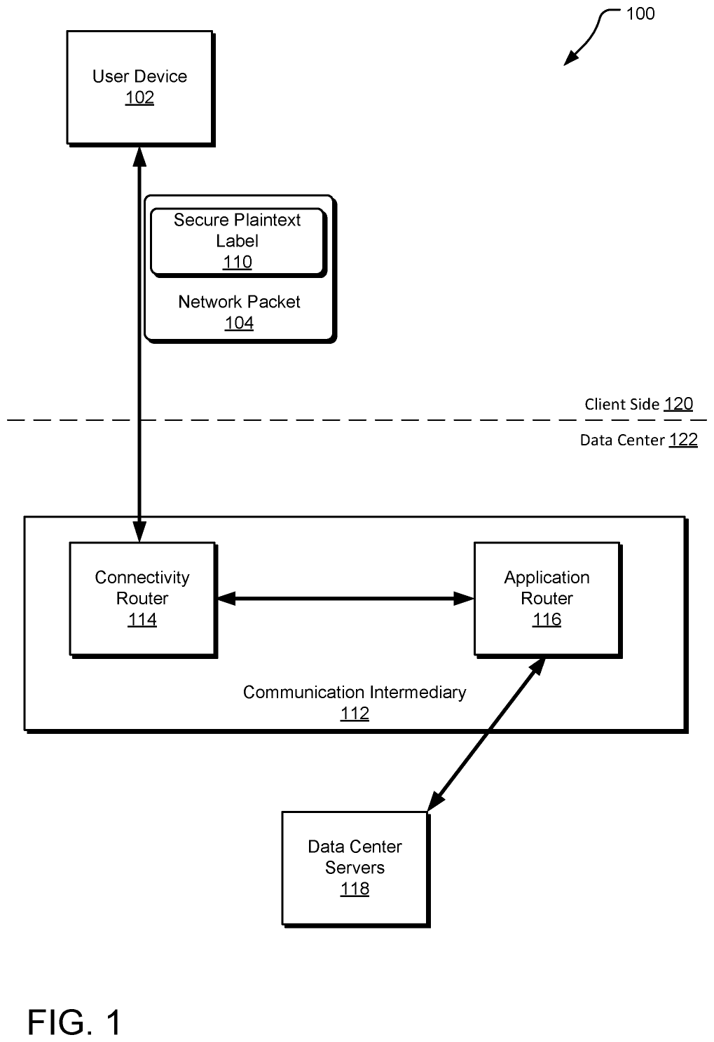

FIG. 1 illustrates an example system 100 for enforcing a communication policy at a communication intermediary 112. The communication intermediary 112 serves as an intermediary for communications between a user device 102 (e.g., a communicating entity) on a client side 120 and data center servers 118 (e.g., a tenant or a different communicating entity) at a data center 122. In the illustrated implementation, communications are bidirectional, such that the user device 102 is one of a communication source or a communication destination, and the data center servers 118 are the other. For purposes of illustration, the communication is described in the system 100 as being transmitted from the user device 102 to the data center servers 118.

The user device 102 transmits a communication, including a network packet 104, to a packet router 114 of the communication intermediary 112. In an implementation, the packet router 114 is configured for L2 or L3 level routing. The network packet 104 includes a plaintext portion that is configured to be accessible to the packet router 114 and an encrypted portion that is configured to be inaccessible by the packet router 114. In implementations, the plaintext portion includes a header, and the encrypted portion includes encrypted content, such as a payload of application-level communication data the user device 102 has requested be communicated with the data center servers 118. In accordance with some network communication protocols (e.g., HyperText Transfer Protocol (HTTP)/3 communication through quick user datagram protocol Internet connections (QUIC) protocol), static communication label data that is usable to classify or label network traffic is stored as encrypted content in the encrypted portion inaccessible to the packet router 114. The communication intermediary 112 further includes an application router 116 that is configured to decrypt and access the encrypted portion to reveal communication data. The decryption and accessing operations of the application router 116 are slow, so relying on the application router 116 for access to the encrypted communication label data may not prevent attacks. In an implementation, the application router 116 and/or the communication intermediary 112 functions as a proxy for the user device 102 and/or the data center servers 118.

To address the change in network protocol, the network packet 104 includes a secure plaintext label 110 in the plaintext portion to which the packet router 114 has access. The secure plaintext label 110 securely represents one or more features of the communication label data. In implementations, the secure plaintext label 110 securely represents the communication label data by the secure plaintext label 110, including an encoding (e.g., encryption or hashing) of the communication label data. The encoding may be a direct encoding (e.g., hashing or ciphering) of the communication label data or may include a generated code associated in memory (e.g., by a mapping or a table) in the communication intermediary 112 with the represented communication label data. The secure plaintext label 110 may additionally or alternatively be secured by being encoded into a communication ID issued by the communication intermediary 112. In implementations in which the secure plaintext label 110 is encoded, the packet router is configured to identify the secure plaintext label 110 by identifying portions (e.g., specific chunks or bytes in a connection identifier) of the plaintext portion dedicated to or allocated specifically for the secure plaintext label 110. For example, the secure plaintext label 110 is positioned at a predefined position within a communication identifier that the communication intermediary 112 assigned to the user device 102. The packet router 114 is configured to identify the secure plaintext label 110, and the communication intermediary 112 is configured to use this early identification by the packet router 114 before the application router 116 is configured to finish decrypting and/or interpreting data in the encrypted portion. In turn, the secure plaintext label 110 can be used to quickly classify the communication with the network packet 104 and determine how to operate on communication(s) that include the secure plaintext label 110.

Examples of communication label data include data representing a source address from which the communication is transmitted, a destination address to which the data is addressed, a server name indicator (SNI), a domain of a tenant in a multi-tenant system to which the data is addressed, a server identifier of a server to which the data is addressed, a geographic location at which the communication was generated, a geolocation of the user device 102, a geolocation of the data center servers 118, a geolocation of the communication intermediary 112, a next hop address to which the data is addressed, a quality of service label (e.g., a subscription level or a service level agreement term) of a user or requestor that generated the communication including the network packet 104, or an identifier of a particular user or subscriber operating the user device 102. The communication intermediary 112 uses the secure plaintext label 110 that represents the communication label data to assess labeled network traffic with one or more common features represented by the communication label data to help identify malicious traffic indicative of an attack.

Example implementations of the presently described technology include a security label implementation and a QoS label implementation. In a security label implementation, the communication intermediary 112 uses the secure plaintext label 110 to secure the data center servers 118 from malicious traffic. For example, the packet router 114 identifies the secure plaintext label 110. The communication intermediary 112 keeps a record of network traffic with the secure plaintext label 110, including each communication or network packet that includes the secure plaintext label 110 identified by one or more instances of the packet router 114. The communication intermediary 112 evaluates whether labeled network traffic, labeled with the secure plaintext label 110, satisfies an enforcement condition of a communication policy.

The enforcement condition may be based on a threshold value or range of values representing a magnitude or rate of network traffic that includes the secure plaintext label 110. For example, the enforcement condition may include a threshold rate of network packets, communication data size, or communications with the secure plaintext label 110 that are processed or accepted. Examples of enforcement conditions in a communication policy can include global enforcement conditions applied to all communications, clients, and/or tenants and/or can include specific enforcement conditions specific to one or more communications, clients, and/or tenants. One example of an enforcement condition is that the communication intermediary 112 receives more than 500,000 network packets with the secure plaintext label 110 in a minute. If the user device 102 (and other communications sources) transmits 500,000 network packets with the secure plaintext label 110 in a minute, the enforcement condition is satisfied.

In implementations, the enforcement condition can differ based on a QoS level associated with the user device 102. For example, the enforcement condition may include a higher threshold rate of network traffic for a user or requester with a higher-level subscription or higher-level term of a service level agreement than the enforcement condition would apply to communications from a lower-level user or requestor. In implementations, the QoS level is a feature of communication label data represented in the secure plaintext label 110 as label classification data.

The communication intermediary 112 instructs a network controller to operate on the network packet based on the evaluation of whether the labeled network traffic satisfies the enforcement condition. If the labeled network traffic that includes the secure plaintext label 110 satisfies the enforcement condition (e.g., indicating that the labeled traffic is greater than a predefined threshold), the communication intermediary 112 can instruct a network controller to take an enforcement action that restricts the transmission of the labeled network traffic. Examples of enforcement actions that restrict the transmission of the labeled network traffic include enforcing a rate limit on communications or requests that include the secure plaintext label, denying the labeled network traffic access to the data center servers 118 and/or the application router 116, blacklisting or flagging the secure plaintext label 110 as representative of a malicious communication, assigning a lower priority to the labeled network traffic relative to other network traffic, or rerouting the labeled network traffic to different parts of the network (e.g., through a more circuitous routing). In implementations, in response to taking an enforcement action that restricts transmission of the labeled network traffic, the communication intermediary 112 transmits a notification to the user device 102 that the labeled network traffic has been restricted. The enforcement actions that limit the labeled network traffic limit damage or disruption to the data center servers 118.

If the labeled network traffic fails to satisfy the enforcement condition (indicating the labeled traffic is not malicious), the communication intermediary may instruct the network controller to process the network packet 104 as part of a communication to the data center servers 118. For example, the network packet 104 is sent from the packet router to the application router 116 as a proxy for the network packet 104 to be decrypted, repackaged, and transmitted to the data center servers 118. Additionally or alternatively, if the network traffic fails to satisfy the enforcement condition, the communication intermediary 112 may whitelist the secure plaintext label 110, increase a priority level of the labeled network traffic relative to other network traffic, reroute the communication to take a less circuitous route through networked routers, or remove an existing flag representative of a malicious communication from the secure plaintext label 110.

In a QoS label implementation, the communication intermediary uses the secure plaintext label 110 to determine how to operate on the labeled network traffic to comply with a communication policy based on a subscription or service level agreement (SLA) term. The secure plaintext label 110 includes QoS communication label data indicative of a QoS level of a requestor or user that generated the network packet 104 at the user device 102. The QoS communication label data is based on a feature of the user device 102 and/or the data center servers 118. In an implementation, the communication intermediary 112 operates on a communication that includes the network packet 104 based on the QoS communication label data represented in the secure plaintext label 110. For example, the communication policy includes enforcement conditions that represent whether a user is generating labeled network traffic in accordance with a predefined QoS level or terms of a predefined SLA term. The communication intermediary 112 evaluates labeled network traffic that includes the secure plaintext label 110 to determine whether an enforcement condition is satisfied. Examples of enforcement conditions include predefined thresholds of ranges of data rate transmitted, hardware resources utilized, hardware resources available (e.g., how busy the data center servers 118 are), routes data communications have taken (e.g., more direct or more circuitous), and the like. The conditions may also be based on a geolocation of the user device 102, the data center servers 118, or the communication intermediary 112. Examples of the different enforcement actions taken on a communication based on different QoS communication label data represented in the secure plaintext label 110 include routing the communication differently, using different hardware or software to process the communication differently, applying different security measures to scrutinize the communication, allowing different network traffic rates for the communication, blacklisting the communication, whitelisting the communication, or any combination thereof. Examples of routing the communication differently include routing through a more or less direct path with fewer routers; through routers located geographically proximally to the user device 102, the communication intermediary 112, and/or the data center servers 118; through routers that are less busy; through routers that are optimized to operate on and/or route the communication; using different hardware; or any combination thereof.

In implementations, the communication intermediary 112 assigns the secure plaintext label 110 to a communication (e.g., a communication, communication sequence, or a session) conducted between the user device 102 and the data center servers 118. In one implementation, the communication intermediary 112 assigns one or more connection identifiers that include the secure plaintext label 110 (e.g., discretely or encoded in the connection identifiers) to the communication. In other implementations, the communication intermediary assigns one or more communication IDs and one or more secure plaintext labels discretely, all associated with the same communication. In an example secure plaintext label assignment operation, the user device 102 initially transmits a request to communicate with the data center servers 118 to the communication intermediary 112 in a handshake or negotiation. In an implementation, the initially transmitted request includes a character string that is randomly generated and serves as an introductory destination communication identifier. In an implementation, the application router 116 interprets the request and generates a response that, in some implementations, the packet router 114 (or a different packet router in the communication intermediary 112) transmits to the user device 102.

In these implementations, the communication intermediary 112 responds to the initially transmitted request with one or more connection identifiers that include (e.g., discretely or encoded into the connection identifiers) the secure plaintext label 110 or multiple destination connection identifiers with one or more secure plaintext labels, each with the same or one or more different versions of the secure plaintext label 110. Using the same instance of the secure plaintext label 110 for multiple connection identifiers is a way to relate all of the connection identifiers the communication intermediary 112 issues to the user device 102 for a session or communication sequence; however, the use of the same instance of the secure plaintext label 110 across multiple connection identifiers may sacrifice some of the security conferred by the network protocol. This is because one reason for issuing multiple connection IDs in the new protocols was to prevent the identification of information about the user device 102 and/or the data center servers 118 from the plaintext portion. The secure nature of the secure plaintext label may mitigate any security sacrificed. Also, if the secure plaintext label is encoded into the communication identifiers, the secure plaintext label should not be readily accessible to communication interceptors. Implementations are also contemplated in which the communication intermediary 112 issues connection identifiers for each of the user device 102 and the data center servers 118, and any of the connection identifiers can include the secure plaintext label 110. Implementations are contemplated in which the secure plaintext label 110 and/or the communication identifiers are generated by the application router 116 or other application routers of the communication intermediary 112.

In implementations, the entire connection identifier is presented in plaintext and is accessible to the packet router 114. In some implementations, the packet router is configured to determine or interpret (e.g., decode or reference in a table that relates the label to) the communication label data that the secure plaintext label 110 is configured to represent. In other implementations, the packet router is configured to read the secure plaintext label 110 without the ability to determine or interpret the communication label data represented by the secure plaintext label 110. In an example implementation, the plaintext portion of the network packet 104 includes a header. Examples of data the header is configured to store include a source port of the user device 102, a destination port of the data center servers 118, a flag or indicator associated with the communication sequence or session that includes the network packet 104, or a connection identifier that includes the secure plaintext label 110.

In some implementations, the data center servers 118, to which the communication that includes the network packet 104 is addressed, is a tenant in a multi-tenant system. In these implementations, the secure plaintext label 110 may represent a server name indicator (SNI) or other identifier of a server or domain of the tenant. The tenant may be an element of the data center 122 that includes the communication intermediary or may be an element of a different data center. The data center servers 118 and or the tenant may include systems that are controlled by the same entity as the communication intermediary with the tenant as a customer or a different entity of the tenant.

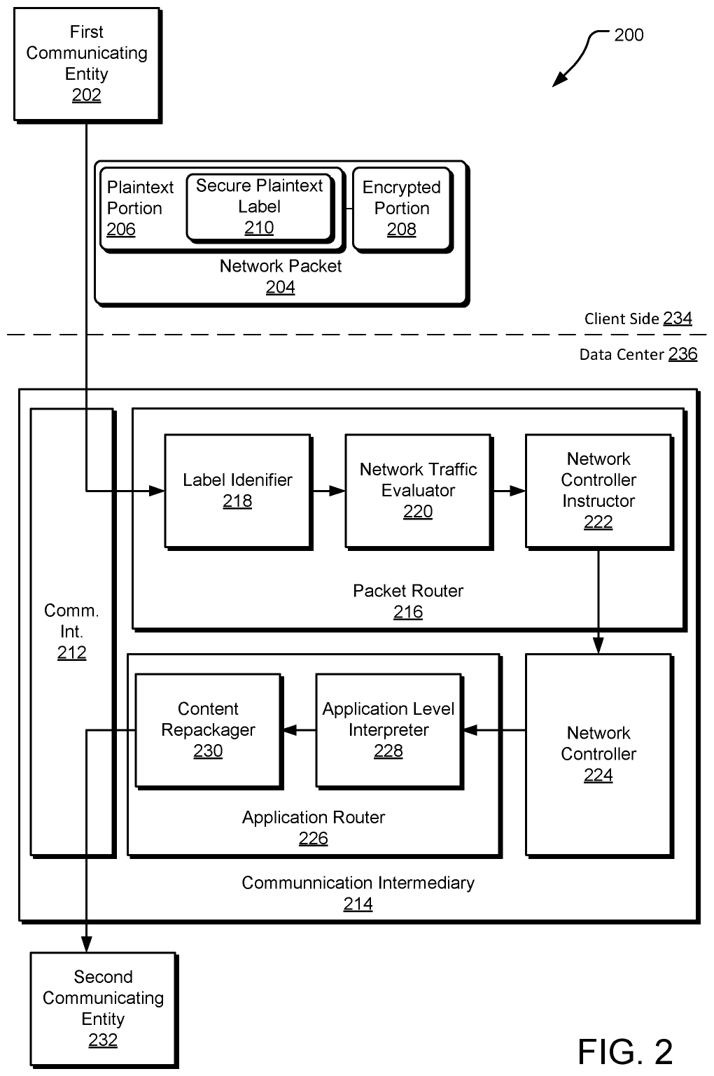

FIG. 2 illustrates a schematic view of an example system 200 for enforcing a communication policy at a communication intermediary 214. A first communicating entity 202 (e.g., a communicating entity or a user device) on a client side 234 initiates a communication with a communication intermediary 214 to communicate with a second communicating entity 232 (e.g., a different communicating entity, a tenant, or data center servers) at a data center 236. The communication includes a network packet 204. The network packet 204 includes a plaintext portion 206 and an encrypted portion 208. The plaintext portion 206 includes a secure plaintext label 210, as described herein.

The network packet 204 is communicated to a packet router 216 in the communication intermediary 214 via a communication interface 212 of the communication intermediary 214. The packet router 216 includes a label identifier 218 configured to identify the secure plaintext label 210 in the network packet 204. A network traffic evaluator 220 of the packet router 216 evaluates whether labeled network traffic, including the secure plaintext label 210, satisfies an enforcement condition of a communication policy, as described herein. A network controller instructor 222 is configured to instruct a network controller 224 to operate on the network packet 204 and or the communication of which the network packet 204 is an element based on the evaluation. For example, the network controller instructor 222 instructs the network controller 224 to operate on the communication or network packet 204 by taking an enforcement action based on whether the network traffic evaluator determines that an enforcement condition is satisfied, as described herein. In a security label implementation, the communication intermediary 214 uses the secure plaintext label 210 to secure the second communicating entity 232 from malicious traffic, as described herein. In a QoS label implementation, the communication intermediary 214 uses the secure plaintext label 210 to determine how to operate on the labeled network traffic (e.g., by an enforcement action) in accordance with a communication policy that is based on a subscription or a service level agreement, as described herein.

In implementations, provided the network controller instructor 222 instructs the network controller 224 to allow (e.g., based on the determination(s) of the network traffic evaluator 220) transmission of the communication, including the network packet 204 to the second communicating entity 232, the network controller 224 instructs an application level interpreter 228 in an application router 226 to interpret the data contained in the network packet 204. For example, the application level interpreter 228 decrypts the encrypted portion 208 of the network packet 204 to reveal communication data, such as payload data and/or communication label data. The communication label data may also be represented in the secure plaintext label 210. A content repackager 230 in the application router 226 repackages the data decrypted from the encrypted portion 208. In implementations, the content repackager packages the payload data with communication label data and or data represented in the plaintext portion 206 of the network packet 204. In implementations, the content repackager 230 further encrypts the repackaged data using the same encryption method as or a different encryption method from the encryption method used to encrypt the encrypted portion 208 prior to the communication. The communication intermediary 214 transmits the repackaged data to the second communicating entity 232 via the communication interface 212.

The system 200 is one example implementation, and variations on the system 200 are contemplated. For example, although illustrated as all being at the data center 236, implementations are contemplated in which any of the communication intermediary 214, components of the communication intermediary 214, and/or the second communicating entity 232 are located in different data centers and/or under the control of different entities. Although illustrated as components of the packet router 216, implementations are contemplated in which the network traffic evaluator 220, the network controller instructor 222, or any combination of their functionality is conducted by a different element at the communication intermediary 214, such as the network controller 224. Although illustrated as components of a single instance of the communication intermediary 214, the packet router 216, the network controller 224, and/or an application router 226 can be in different data centers, at different instances of the communication intermediary 214, and/or under the control of different entities.

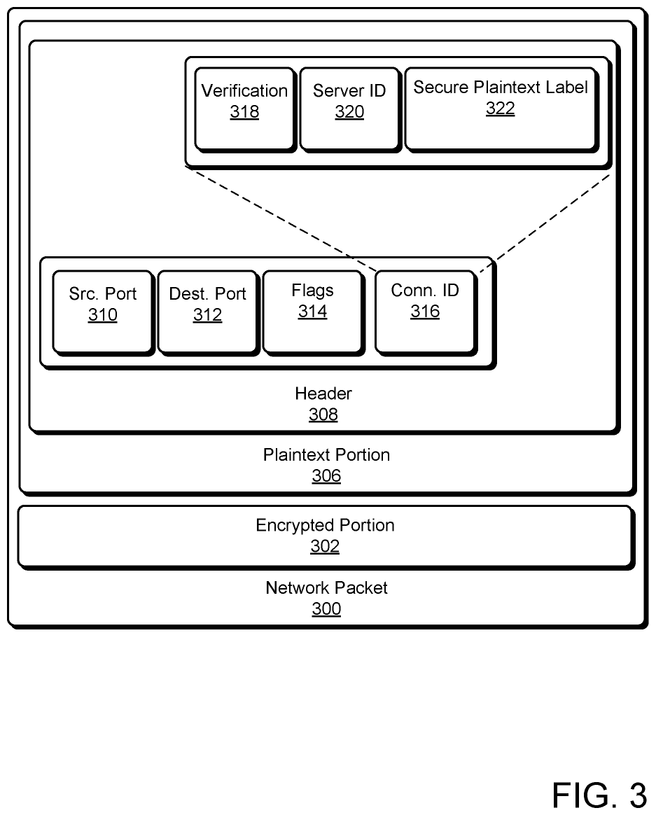

FIG. 3 illustrates an example network packet 300 including a secure plaintext label 322. The network packet includes an encrypted portion 302 and a plaintext portion 306. The encrypted portion includes cipher text representing the encrypted payload and/or static communication label data configured to be inaccessible to a packet router. The plaintext portion 306 includes a header 308 (e.g., a short or long QUIC header). The header includes a source port 310 of a communication source, a destination port 312 of a communication destination, flags 314 that indicate one or more states of the communication, and a connection identifier 316. The connection identifier 316 is useable by packet routers to identify a communication (e.g., a session or communication sequence) or a quality of service level, as described herein.

In the illustrated implementation, the connection identifier 316 includes a verification 318 indicating a verification method value (e.g., a checksum byte), a server identifier 320 that identifies a destination server or set of servers to which the network packet 300 is addressed, and the secure plaintext label 322. Other combinations of elements described herein are contemplated. The verification 318, server identifier 320, and secure plaintext label 322 are illustrated as discrete elements. However, implementations are contemplated in which the connection identifier 316 is an encoding of these or other static communication label data. In other implementations, the secure plaintext label 322 is incorporated into the header as an element separate of the secure plaintext label 322. In alternative embodiments, the connection identifier 316 further includes (discretely or as part of an encoding) one of one or more destination connection identifiers issued by the communication intermediary as part of a negotiation or handshake, as described herein. In one implementation, the secure plaintext label 322 is encoded (e.g., hashed) data representing a server name indication (SNI).

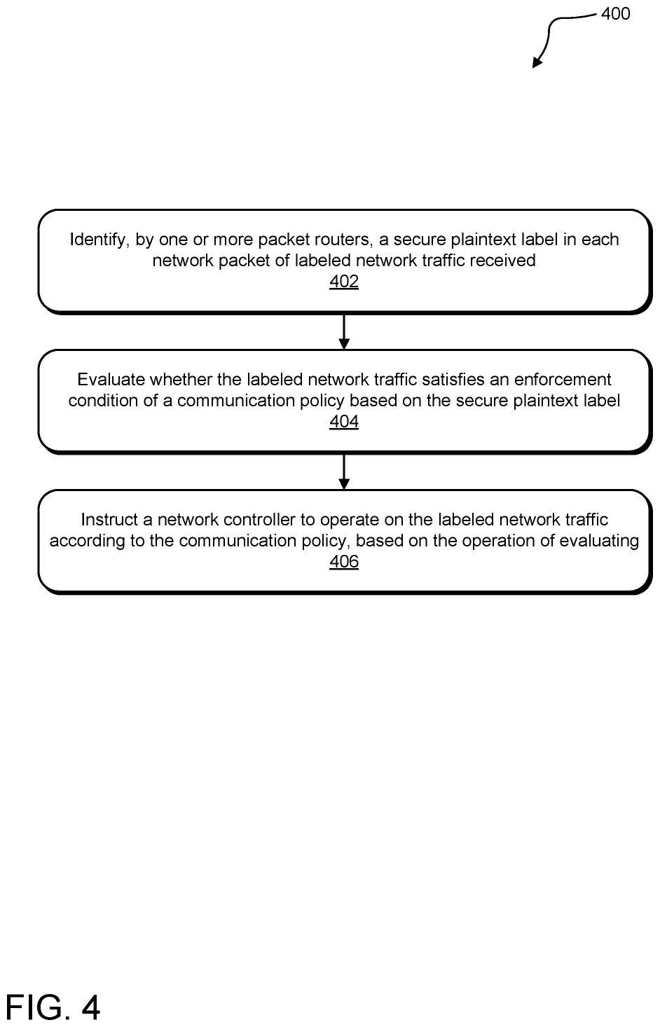

FIG. 4 illustrates example operations 400 for enforcing a communication policy at a communication intermediary. In an implementation, the communication intermediary is configured to communicate between a first communicating entity and a second communicating entity using one or more packet routers,

An identifying operation 402 identifies, by the one or more packet routers, a secure plaintext label in each network packet of labeled network traffic received at the one or more packet routers. Each network packet further includes encrypted content configured to be inaccessible by the one or more packet routers. The secure plaintext label is accessible (e.g., readable, interpretable, translatable, or decodable) by the one or more packet routers. The secure plaintext label includes data representing a portion of the encrypted content. The identifying operation 402 identifies the secure plaintext label using the packet router, as described herein. In an implementation, the secure plaintext label was assigned for inclusion in each network packet in a communication between the communication source and the communication intermediary, and the identifying operation 402 is responsive to the assignment. The identifying operation 402 may be conducted by a label identifier of the packet router, as described herein.

In an implementation, the data representing the portion of the encrypted content includes a data encoding (e.g., an encoded representation) of static communication label data, as described herein. In one implementation, the data representing the portion of the encrypted content represents a domain of a tenant of the communication destination to which the network packet is directed, the tenant being one of multiple tenants in a multi-tenant system. In another implementation, the data representing the portion of the encrypted content includes an encoded representation of static communication label data other than data represented in the encrypted portion. In implementations, the data representing the portion of the encrypted content includes data representing a domain identifier of a destination domain of the communication destination, a server name indication of a server at the communication destination, a quality of service label associated in data with the communication source, or a geolocation associated in data with the communication source. The secure plaintext label may be positioned at a predefined position within a communication identifier that the communication intermediary assigned to the communication source. Other example implementations of the secure plaintext label are described herein.

An evaluating operation 404 evaluates whether the labeled network traffic satisfies an enforcement condition of the communication policy based on the secure plaintext label. For example, the evaluating operation 404 evaluates whether labeled network traffic, including the secure plaintext label and communication data to be transmitted to the communication destination, satisfies an enforcement condition of the communication policy, as described herein. In implementations, the evaluating operation 404 uses a network traffic evaluator to evaluate the labeled network traffic that includes the secure plaintext label to determine whether the labeled network traffic satisfies the enforcement condition, as described herein. Other implementations of enforcement conditions in the communication policy are described herein.

An instructing operation 406 instructs a network controller to operate on the labeled network traffic according to the communication policy based on the operation of evaluating. For example, in an implementation, the instructing operation 406 takes an enforcement action in response to determining that an enforcement condition of the communication policy is satisfied. In implementations, the instructing operation 406 includes an instruction to operate on the network packet to restrict the transmission of the network packet to the communication destination, responsive to determining that the labeled network traffic satisfies the enforcement condition. Other implementations of enforcement actions are described herein. In implementations, if the evaluating operation 404 determines that the labeled network traffic fails to satisfy the enforcement condition, the data requested to be communicated in the communication sequence, including the network packet, is communicated with the communication destination. For example, an application router decrypts or interprets the data in the communication sequence, repackages the data, and transmits the repackaged data to the communication destination, as described herein.

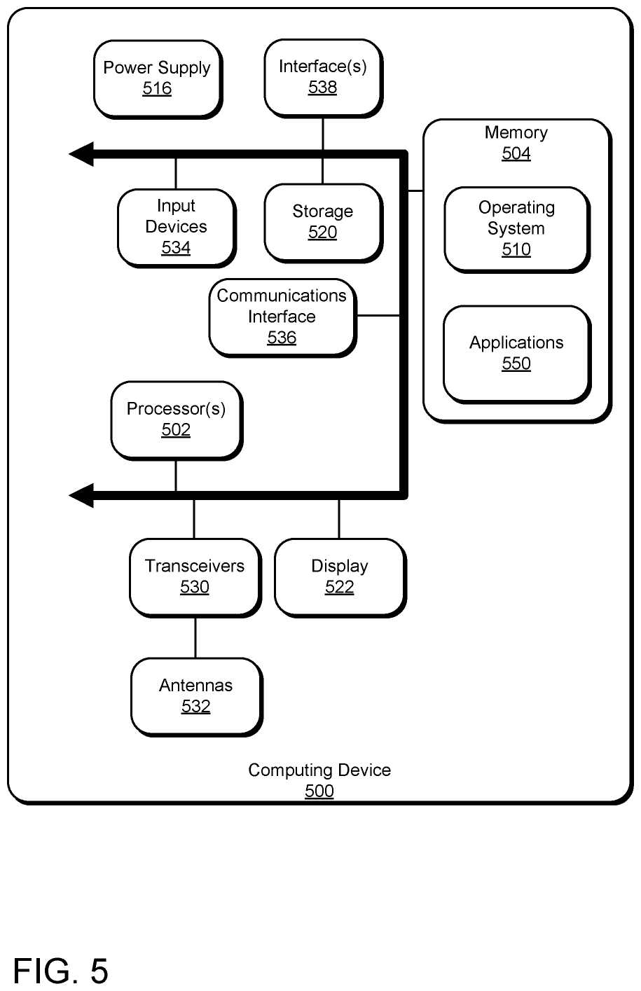

FIG. 5 illustrates an example computing device 500 for use in implementing the described technology. The computing device 500 may be a client computing device (such as a laptop computer, a desktop computer, or a tablet computer), a server/cloud computing device, an Internet-of-Things (IoT), any other type of computing device, or a combination of these options. The computing device 500 includes one or more processor(s) 502 (e.g., one or more hardware processors) and a memory 504. The memory 504 generally includes both volatile memory (e.g., RAM) and nonvolatile memory (e.g., flash memory), although one or the other type of memory may be omitted. An operating system 510 resides in the memory 504 and is executed by the one or more processor(s) 502. In some implementations, the computing device 500 includes and/or is communicatively coupled to storage 520.

In the example computing device 500, as shown in FIG. 5, one or more modules or segments, such as applications 550, a packet router, a label identifier, a network traffic evaluator, a network controller instructor, a network controller, an application router, an application level interpreter, a content repackager, a communication interface routine, an encryptor, a decryptor, and other program code and modules are loaded into the operating system 510 on the memory 504 and/or the storage 520 and executed by the one or more processor(s) 502. The storage 520 may store a communication, a network packet, a plaintext portion, an encrypted portion, a secure plaintext label, communication label data, a server name indicator, a domain identifier, encrypted content, communication data, a communication policy, an enforcement condition, a network controller instruction, a data table relating a generated code to communication label data, encoded communication label data, and other data and be local to the computing device 500 or may be remote and communicatively connected to the computing device 500. In particular, in one implementation, components of a system including a label identifier of a packet router configured to identify a secure plaintext label received in a network packet at the communication intermediary, a network traffic evaluator e configured to evaluate whether labeled network traffic including the secure plaintext label and communication data to be transmitted to the communication destination satisfies an enforcement condition of the communication policy, and/or a network controller instructor configured to instruct a network controller to operate on the network packet, based on the operation of evaluating may be implemented entirely in hardware or in a combination of hardware circuitry and software.

The computing device 500 includes a power supply 516, which may include or be connected to one or more batteries or other power sources and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers, client devices, IoT devices, and other computing and communications devices. The computing device 500 may further include a communications interface 536 (such as a network adapter or an I/O port, which are types of communication devices). The computing device 500 may use the adapter and any other types of communication devices for establishing connections over a wide-area network (WAN) or local-area network (LAN). It should be appreciated that the network connections shown are exemplary and that other communications devices and means for establishing a communications link between the computing device 500 and other devices may be used.

The computing device 500 may include one or more input devices 534 such that a user may enter commands and information (e.g., a keyboard, trackpad, or mouse). These and other input devices may be coupled to the server by one or more interfaces 538, such as a serial port interface, parallel port, or universal serial bus (USB). Other interfaces may include a sensor or an actuator. The actuator may be configured to move responsive to the sensors (e.g., in a feedback loop) and may be used to execute any operations described herein. The computing device 500 may further include a display 522, such as a touchscreen display.

The computing device 500 may include a variety of tangible processor-readable storage media and intangible processor-readable communication signals. Tangible processor-readable storage can be embodied by any available media that can be accessed by the computing device 500 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of enforcing a communication policy at a communication intermediary configured to communicate between a first communicating entity and a second communicating entity, wherein the communication intermediary includes one or more packet routers, the method comprising: identifying, by the one or more packet routers, a secure plaintext label in each network packet of labeled network traffic received at the one or more packet routers, each network packet further including encrypted content configured to be inaccessible by the one or more packet routers, the secure plaintext label being accessible by the one or more packet routers and including a data encoding of a portion of the encrypted content; evaluating whether the labeled network traffic satisfies an enforcement condition of the communication policy based on the secure plaintext label; and instructing a network controller to operate on the labeled network traffic according to the communication policy, based on the operation of evaluating.

Clause 2. The method of clause 1, wherein the operation of instructing includes an instruction to operate on the labeled network traffic to restrict transmission of the labeled network traffic from the communication intermediary, responsive to determining that the labeled network traffic satisfies the enforcement condition.

Clause 3. The method of clause 1, wherein the data encoding includes an encoded representation of a domain of a tenant to which the labeled network traffic is directed, the tenant being one of multiple tenants in a multi-tenant system.

Clause 4. The method of clause 1, wherein each network packet includes a connection identifier generated in a handshake between the first communicating entity and the second communicating entity prior to the operation of identifying, the connection identifier including the secure plaintext label.

Clause 5. The method of clause 1, wherein the data encoding includes data representing a domain identifier of a destination domain of a communication destination, a server name indication of a server at the communication destination, a quality of service label associated in data with a communication source, or a geolocation associated in data with a communication source.

Clause 6. The method of clause 1, wherein the secure plaintext label is included in each network packet of a communication sequence between the first communicating entity and the communication intermediary.

Clause 7. The method of clause 1, wherein the secure plaintext label is positioned at a predefined position within a communication identifier in a header of each network packet.

Clause 8. The method of clause 1, wherein the data encoding includes data representing a server name indication.

Clause 9. A system for enforcing a communication policy at a communication intermediary configured to communicate between a first communicating entity and a second communicating entity, the system comprising: one or more hardware processors; one or more packet routers including a label identifier configured to identify a secure plaintext label in each network packet of labeled network traffic received at the one or more packet routers, each network packet further including encrypted content configured to be inaccessible by the one or more packet routers, the secure plaintext label being accessible by the one or more packet routers and including a data encoding of a portion of the encrypted content; a network traffic evaluator executable by the one or more hardware processors and configured to evaluate whether the labeled network traffic satisfies an enforcement condition of the communication policy based on the secure plaintext label; and a network controller instructor executable by the one or more hardware processors and configured to instruct a network controller to operate on the labeled network traffic according to the communication policy, based on the evaluation.

Clause 10. The system of clause 9, wherein the network controller instructor is configured to instruct the network controller to operate on the labeled network traffic to restrict transmission of the labeled network traffic from the communication intermediary, responsive to the network traffic evaluator determining that the labeled network traffic satisfies the enforcement condition.

Clause 11. The system of clause 9, wherein the data encoding includes an encoded representation of a domain of a tenant to which the labeled network traffic is directed, the tenant being one of multiple tenants in a multi-tenant system.

Clause 12. The system of clause 9, wherein each network packet includes a connection identifier generated in a handshake operation between the first communicating entity and the second communicating entity prior to the label identifier identifying the secure plaintext label, the connection identifier including the secure plaintext label.

Clause 13. The system of clause 9, wherein the data encoding includes data representing a domain identifier of a destination domain of a communication destination, a server name indication of a server at the communication destination, a quality of service label associated in data with a communication source, or a geolocation associated in data with a communication source.

Clause 14. The system of clause 9, wherein the secure plaintext label is included in each network packet of a communication sequence between the first communicating entity and the communication intermediary.

Clause 15. One or more tangible processor-readable storage media embodied with instructions for executing on one or more processors and circuits of a computing device a process for enforcing a communication policy at a communication intermediary configured to communicate between a first communicating entity and a second communicating entity, the process comprising: identifying, by one or more packet routers of the communication intermediary, a secure plaintext label in each network packet of labeled network traffic received at the one or more packet routers, each network packet further including encrypted content configured to be inaccessible by the one or more packet routers, the secure plaintext label being accessible by the one or more packet routers and including a data encoding of a portion of the encrypted content; evaluating whether the labeled network traffic satisfies an enforcement condition of the communication policy based on the secure plaintext label; and instructing a network controller to operate on the labeled network traffic according to the communication policy, based on the operation of evaluating.

Clause 16. The one or more tangible processor-readable storage media of clause 15, wherein the operation of instructing includes an instruction to restrict transmission of the labeled network traffic from the communication intermediary, responsive to determining that the labeled network traffic satisfies the enforcement condition.

Clause 17. The one or more tangible processor-readable storage media of clause 15, wherein the data encoding includes an encoded representation of a domain of a tenant to which each network packet is directed, the tenant being one of multiple tenants in a multi-tenant system.

Clause 18. The one or more tangible processor-readable storage media of clause 15, wherein each network packet includes a connection identifier generated in a handshake between the first communicating entity and the second communicating entity prior to the operation of identifying, the connection identifier including the secure plaintext label.

Clause 19. The one or more tangible processor-readable storage media of clause 15, wherein the secure plaintext label is positioned at a predefined position within a communication identifier in a header of each network packet, and the operation of identifying identifies the secure plaintext label at the predefined position.

Clause 20. The one or more tangible processor-readable storage media of clause 15, wherein the data encoding includes a representation of a server name indication.

An example system for enforcing a communication policy at a communication intermediary configured to communicate between a first communicating entity and a second communicating entity is provided. The communication intermediary includes one or more packet routers. The system includes means for identifying, by the one or more packet routers, a secure plaintext label in each network packet of labeled network traffic received at the one or more packet routers, each network packet further including encrypted content configured to be inaccessible by the one or more packet routers, the secure plaintext label being accessible by the one or more packet routers and including a data encoding of a portion of the encrypted content; means for evaluating whether the labeled network traffic satisfies an enforcement condition of the communication policy based on the secure plaintext label; and means for instructing a network controller to operate on the labeled network traffic according to the communication policy, based on the evaluation.

Another example system of any preceding system is provided, wherein the instruction includes an instruction to operate on the labeled network traffic to restrict transmission of the labeled network traffic from the communication intermediary, responsive to determining that the labeled network traffic satisfies the enforcement condition.

Another example system of any preceding system is provided, wherein the data encoding includes an encoded representation of a domain of a tenant to which the labeled network traffic is directed, the tenant being one of multiple tenants in a multi-tenant system.

Another example system of any preceding system is provided, wherein each network packet includes a connection identifier generated in a handshake between the first communicating entity and the second communicating entity prior to the operation of identifying, the connection identifier including the secure plaintext label.

Another example system of any preceding system is provided, wherein the data encoding includes data representing a domain identifier of a destination domain of a communication destination, a server name indication of a server at the communication destination, a quality of service label associated in data with a communication source, or a geolocation associated in data with a communication source.

Another example system of any preceding system is provided, wherein the secure plaintext label is included in each network packet of a communication sequence between the first communicating entity and the communication intermediary.

Another example system of any preceding system is provided, wherein the secure plaintext label is positioned at a predefined position within a communication identifier in a header of each network packet.

Another example system of any preceding system is provided, wherein the data encoding includes data representing a server name indication.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax for instructing a computer to perform a certain operation segment. The instructions may be implemented using any suitable high-level, low-level, object-oriented, visual, compiled, and/or interpreted programming language.

The implementations described herein may be implemented as logical steps in one or more computer systems. The logical operations may be implemented (1) as a sequence of processor-implemented steps executing in one or more computer systems or (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order unless explicitly claimed otherwise or a specific order is inherently necessitated by the claim language.

While this specification contains many specific implementation details, these should not be construed as limitations on the scope of any technologies or of what may be claimed but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination. Other implementations are within the scope of the following claims. Nevertheless, it will be understood that various modifications can be made without departing from the spirit and scope of the recited claims.

What is claimed is:

1. A method of enforcing a communication policy at a communication intermediary configured to communicate between a first communicating entity and a second communicating entity, wherein the communication intermediary includes one or more packet routers, the method comprising:
identifying, by the one or more packet routers, a secure plaintext label in each network packet of labeled network traffic received at the one or more packet routers, each network packet further including encrypted content configured to be inaccessible by the one or more packet routers, the secure plaintext label being accessible by the one or more packet routers and including a data encoding of a portion of the encrypted content;
evaluating whether the labeled network traffic satisfies an enforcement condition of the communication policy based on the secure plaintext label; and
instructing a network controller to operate on the labeled network traffic according to the communication policy, based on the operation of evaluating.

2. The method of claim 1, wherein the operation of instructing includes an instruction to operate on the labeled network traffic to restrict transmission of the labeled network traffic from the communication intermediary, responsive to determining that the labeled network traffic satisfies the enforcement condition.

3. The method of claim 1, wherein the data encoding includes an encoded representation of a domain of a tenant to which the labeled network traffic is directed, the tenant being one of multiple tenants in a multi-tenant system.

4. The method of claim 1, wherein each network packet includes a connection identifier generated in a handshake between the first communicating entity and the second communicating entity prior to the operation of identifying, the connection identifier including the secure plaintext label.

5. The method of claim 1, wherein the data encoding includes data representing a domain identifier of a destination domain of a communication destination, a server name indication of a server at the communication destination, a quality of service label associated in data with a communication source, or a geolocation associated in data with a communication source.

6. The method of claim 1, wherein the secure plaintext label is included in each network packet of a communication sequence between the first communicating entity and the communication intermediary.

7. The method of claim 1, wherein the secure plaintext label is positioned at a predefined position within a communication identifier in a header of each network packet.

8. The method of claim 1, wherein the data encoding includes data representing a server name indication.

9. A system for enforcing a communication policy at a communication intermediary configured to communicate between a first communicating entity and a second communicating entity, the system comprising:
one or more hardware processors;
one or more packet routers including a label identifier configured to identify a secure plaintext label in each network packet of labeled network traffic received at the one or more packet routers, each network packet further including encrypted content configured to be inaccessible by the one or more packet routers, the secure plaintext label being accessible by the one or more packet routers and including a data encoding of a portion of the encrypted content;
a network traffic evaluator executable by the one or more hardware processors and configured to evaluate whether the labeled network traffic satisfies an enforcement condition of the communication policy based on the secure plaintext label; and
a network controller instructor executable by the one or more hardware processors and configured to instruct a network controller to operate on the labeled network traffic according to the communication policy, based on the evaluation.

10. The system of claim 9, wherein the network controller instructor is configured to instruct the network controller to operate on the labeled network traffic to restrict transmission of the labeled network traffic from the communication intermediary, responsive to the network traffic evaluator determining that the labeled network traffic satisfies the enforcement condition.

11. The system of claim 9, wherein the data encoding includes an encoded representation of a domain of a tenant to which the labeled network traffic is directed, the tenant being one of multiple tenants in a multi-tenant system.

12. The system of claim 9, wherein each network packet includes a connection identifier generated in a handshake operation between the first communicating entity and the second communicating entity prior to the label identifier identifying the secure plaintext label, the connection identifier including the secure plaintext label.

13. The system of claim 9, wherein the data encoding includes data representing a domain identifier of a destination domain of a communication destination, a server name indication of a server at the communication destination, a quality of service label associated in data with a communication source, or a geolocation associated in data with a communication source.

14. The system of claim 9, wherein the secure plaintext label is included in each network packet of a communication sequence between the first communicating entity and the communication intermediary.

15. One or more tangible processor-readable storage media embodied with instructions for executing on one or more processors and circuits of a computing device a process for enforcing a communication policy at a communication intermediary configured to communicate between a first communicating entity and a second communicating entity, the process comprising:
identifying, by one or more packet routers of the communication intermediary, a secure plaintext label in each network packet of labeled network traffic received at the one or more packet routers, each network packet further including encrypted content configured to be inaccessible by the one or more packet routers, the secure plaintext label being accessible by the one or more packet routers and including a data encoding of a portion of the encrypted content;
evaluating whether the labeled network traffic satisfies an enforcement condition of the communication policy based on the secure plaintext label; and
instructing a network controller to operate on the labeled network traffic according to the communication policy, based on the operation of evaluating.

16. The one or more tangible processor-readable storage media of claim 15, wherein the operation of instructing includes an instruction to restrict transmission of the labeled network traffic from the communication intermediary, responsive to determining that the labeled network traffic satisfies the enforcement condition.

17. The one or more tangible processor-readable storage media of claim 15, wherein the data encoding includes an encoded representation of a domain of a tenant to which each network packet is directed, the tenant being one of multiple tenants in a multi-tenant system.

18. The one or more tangible processor-readable storage media of claim 15, wherein each network packet includes a connection identifier generated in a handshake between the first communicating entity and the second communicating entity prior to the operation of identifying, the connection identifier including the secure plaintext label.

19. The one or more tangible processor-readable storage media of claim 15, wherein the secure plaintext label is positioned at a predefined position within a communication identifier in a header of each network packet, and the operation of identifying identifies the secure plaintext label at the predefined position.

20. The one or more tangible processor-readable storage media of claim 15, wherein the data encoding includes a representation of a server name indication.
